(19) United States
(12) Patent Application Publication
(10) Pub. No.: US 2005/0141616 A1
(43) Pub. Date: Jun. 30, 2005

(54) Video encoding and decoding methods and apparatuses using mesh-based motion compensation

(75) Inventor: Dong-keun Lim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/018,695

(22) Filed: Dec. 22, 2004

(30) Foreign Application Priority Data
Dec. 30, 2003 (KR) 2003-100402

(51) Int. Cl. H04N 7/12

(52) U.S. Cl. 375/240.16; 375/240.12; 375/240.24

(57) ABSTRACT

A video encoding and decoding method and apparatus using mesh-based motion compensation are provided. The video encoding method based on motion compensation includes making a coding priority map representing at least one block to be encoded prior to other blocks among all blocks in a current image based on an error between the current image and a reference image and a predetermined bitrate, and encoding the at least one block represented on the coding priority map among the blocks in the current image.

### BACKGROUND OF THE INVENTION

This application claims priority from Korean Patent Application No. 2003-100402, filed on Dec. 30, 2003, in the Korean Intellectual Property Office, the disclosure of which is incorporated herein in its entirety by reference.

1. Field of the Invention

The present invention relates to the technology of video encoding and decoding, and more particularly, to video encoding and decoding methods and apparatuses using mesh-based motion compensation.

2. Description of the Related Art

Video encoding is a process of converting an analog video signal into digital codes distinguished from each other by the existence or non-existence of a unit pulse. Generally, video encoding is performed in units of blocks. Moving Picture Experts Group (MPEG) encoding is a representative block-based encoding method.

FIG. 1 illustrates a conventional block-based video encoding apparatus. Referring to FIG. 1, the video encoding apparatus complying with an MPEG standard includes a motion estimation/motion compensation (ME/MC) unit 118, a discrete cosine transformation (DCT) unit 104, an inverse DCT (IDCT) unit 114, a quantization (Q) unit 106, an inverse Q (IQ) unit 112, a rate control unit 108, and a coding unit 110.

When an image similar to a current image to be encoded has been encoded, the ME/MC unit 118 removes redundancy using estimation, thereby increasing coding efficiency.

The DCT unit 104 decomposes an image signal in a time axis into a plurality of high-frequency regions having a large signal power and a plurality of low-frequency regions having a small signal power. Since an image signal power is concentrated on a low-frequency region, data can be compressed with a small number of bits by quantizing the data with an appropriate bit distribution.

The Q unit 106 quantizes a discrete cosine transformed image signal.

The IQ unit 112 and the IDCT unit 114 perform IQ and IDCT, respectively, on discrete cosine transformed and quantized information to obtain a previous reference image used to acquire a residual image.

The rate control unit 108 controls a bitrate by adjusting a Q parameter (QP) when a residual image formed by a difference between a current image and a previous reference image is encoded. In detail, since a compression rate is increased when the QP is increased, the bitrate is also increased. Conversely, since the compression rate is decreased when the QP is decreased, the bitrate is also decreased. However, a high compression rate may deepen deterioration of picture quality.

The coding unit 110 entropy encodes a motion vector obtained by the ME/MC unit 118 or quantized DCT coefficients using variable length coding (VLC) and/or run length coding (RLC).

In block-based coding, an input image is divided into a plurality of rectangular sections having a predetermined size. Each region is referred to as a block or a macro block (MB), which is a minimum coding unit. The following description concerns a block-based coding method.

Generally, an MB having a size of 16×16 pixels is used for motion estimation. A size of an MB or a block may vary with standards. Here, for clarity of the description, it is assumed that an MB has a size of 16×16 pixels. A search region is set in a temporally previous image around the same position as that of a current MB in a current image to be larger than the current MB. A portion having a least error with the current MB is searched for in the search region. Then, a motion vector of the current MB is obtained and coded before being transmitted to a decoder. Through such operations, motion vectors of all MBs in the current image are obtained, and a motion compensated image is obtained using the motion vectors.

Thereafter, a residual image is obtained by a difference between the motion compensated image and the current image. DCT is performed on the residual image in units of 8×8 blocks. Among DCT coefficients resulting from the DCT, DCT coefficients corresponding to a frequency to which human sight is insensitive are quantized to reduce the number of bits to be encoded. The motion vectors and the quantized DCT coefficients are entropy encoded using VLC and/or RLC. Rate control is performed by adjusting a QP when the residual image is encoded.

Meanwhile, the block-based coding method uses a simple motion model considering only translation, as shown in Equation (1), for motion estimation.
Iₖ(x,y)=Iₖ₋₁(x+dx,y+dy) (1)

Here, Iₖ is a current image, Iₖ₋₁ is a temporally previous reference image, and (dx,dy) is a motion vector at a current position.

As described above, in the conventional block-based coding method, rate control is performed by adjusting the QP when the residual image obtained after MC is encoded, instead of adjusting an amount of a motion vector. The adjusting of the QP is efficient when a satisfactory bitrate is ensured. However, if the conventional simple motion model is used to reduce the bitrate when the satisfactory bitrate is not ensured, a motion in an image cannot be satisfactorily represented, thereby causing serious image deterioration.

In addition, since the conventional simple motion model considers only a simple motion such as translation, a complex motion including translation, rotation, scaling, etc. in an actual image cannot be effectively represented. Accordingly, discontinuity between blocks results in a serious blocking artifact where block boundaries are noticeable in a low bitrate. Such discontinuity in a motion between images and the resulting blocking artifact affect human sight more than an error within a single image.

Moreover, in the conventional block-based coding method, MBs in an image are encoded only in positional order, but an approach of encoding a portion having a large error between images or an important portion prior to other portions to improve the entire quality of a restored image cannot be used.

### SUMMARY OF THE INVENTION

The present invention provides a video encoding method and apparatus for controlling a bitrate using an affine motion model capable of effectively representing an object's translation, rotation, scaling, etc., thereby effectively representing an image with a small amount of motion information.

The present invention also provides a video encoding method and apparatus for controlling a bitrate by encoding a portion having a large error between images prior to other portions, thereby providing desired picture quality at a limited bitrate. Such technology can be used to provide various types of Quality of Service (QoS) in various applications including video service in a low-bitrate environment such as wireless communication.

According to an exemplary embodiment of the present invention, there is provided a video encoding method based on motion compensation, including making a coding priority map representing at least one block to be encoded prior to other blocks among all blocks in a current image based on an error between the current image and a reference image and a predetermined bitrate, and encoding the at least one block represented on the coding priority map among the blocks in the current image.

The making of the coding priority map may include obtaining block mean errors between the current image and the reference image and arranging the blocks in order of block mean error size, determining a predetermined number of blocks to be encoded prior to other blocks among the arranged blocks according to the predetermined bitrate, and making the coding priority map representing the predetermined number of blocks and positions of respective control points of the predetermined number of blocks.

The encoding of the at least one block may include compensating for motion vectors of the respective control points of the predetermined number of blocks based on the coding priority map, and encoding the compensated motion vectors and the coding priority map and transmitting encoded results to a decoding apparatus.

The determining of the predetermined number of blocks may include adjusting either of a number of blocks to be encoded prior to other blocks among all of the blocks in the current image and a number of control points of the blocks to be encoded, thereby satisfying the predetermined bitrate.

The compensation of the motion vectors may include compensating for the motion vectors of the respective control points of the predetermined number of blocks based on the coding priority map using mesh-based motion compensation, and stopping the compensation when the compensated motion vectors reach a predetermined threshold.

The predetermined threshold may be set by a user's input or may be set through simulation in one condition among a number of bits to be coded, Quality of Service (QoS), and computing time.

The mesh-based motion compensation may be a process of compensating for the motion vectors of the respective control points of the predetermined number of blocks using an affine motion model.

According to another exemplary embodiment of the present invention, there is provided a video encoding apparatus based on motion compensation, including a coding priority control unit making a coding priority map representing at least one block to be encoded prior to other blocks among all blocks in a current image based on an error between the current image and a reference image and a predetermined bitrate, and a coding unit encoding the at least one block represented on the coding priority map among the blocks in the current image.

The video encoding apparatus may further include a motion estimation/motion compensation unit compensating for motion vectors of respective control points of a predetermined number of blocks based on the coding priority map and transmitting the compensated motion vectors and the coding priority map to the coding unit, and a rate control unit stopping the compensating for the motion vectors of the respective control points when the compensated motion vectors reach a predetermined threshold.

According to still another exemplary embodiment of the present invention, there is provided a video decoding method based on motion compensation, including receiving a coding priority map, which represents at least one block encoded prior to other blocks in a current image based on an error between the current image and a reference image and a predetermined bitrate, from an encoding apparatus, and extracting the at least one block that was encoded prior to the other blocks; and decoding the at least one block extracted from the coding priority map.

According to yet another exemplary embodiment of the present invention, there is provided a video decoding apparatus based on motion compensation, including a coding priority extraction unit receiving a coding priority map, which represents at least one block encoded prior to other blocks in a current image based on an error between the current image and a reference image and a predetermined bitrate, and extracting the at least one block that was encoded prior to the other blocks; and a decoding unit decoding the at least one block extracted from the coding priority map.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a conventional block-based video encoding apparatus;

FIG. 2 illustrates a mesh-based video encoding apparatus according to an embodiment of the present invention;

FIG. 3 is a flowchart of a mesh-based video encoding method according to an exemplary embodiment of the present invention;

FIG. 4 is a detailed flowchart of the mesh-based video encoding method according to the embodiment illustrated in FIG. 3;

FIGS. 5A and 5B illustrate distributions of block mean square errors (bMSEs) between a current image and a reference image;

FIG. 6 illustrates examples of a coding priority map used in exemplary embodiments of the present invention;

FIGS. 7A and 7B illustrate motion compensation using an affine motion model according to an exemplary embodiment of the present invention; and

FIGS. 8 and 9 illustrate mesh structures according to bitrates in exemplary embodiments of the present invention.

### DETAILED DESCRIPTION OF THE ILLUSTRATIVE, NON-LIMITING EMBODIMENTS OF THE INVENTION

Hereinafter, the present invention will be described in detail by explaining exemplary embodiments of the invention with reference to the attached drawings.

In exemplary embodiments of the present invention, a more affine motion model than a conventional simple motion model is used. In addition, during video encoding, a map of portions in an image is made in descending order of error between images, and computing power for motion estimation and bits for encoding a motion vector are assigned to a portion having a large error between the images prior to a portion having a small error between the images. In other words, a motion vector at a control point (CP) of a mesh to be encoded prior to other meshes is processed in units of n % of a total number of blocks prior to other motion vectors.

Accordingly, since a more affine motion model is used in the exemplary embodiments of the present invention than in conventional block-based encoding, a motion of a block can be more effectively represented with a small amount of information. In addition, since computing power and encoding bits are selectively assigned to a block having higher significance than other blocks prior to the other blocks, encoding efficiency can be increased.

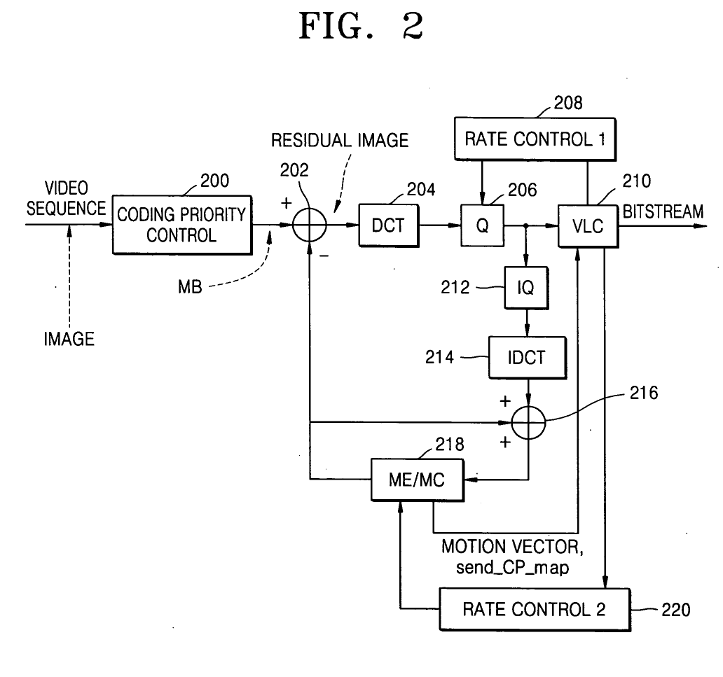

FIG. 2 illustrates a mesh-based video encoding apparatus according to an exemplary embodiment of the present invention. Referring to FIG. 2, the video encoding apparatus includes a coding priority control unit 200, a motion estimation/motion compensation (ME/MC) unit 218, a second rate control unit 220, a discrete cosine transform (DCT) unit 204, an inverse DCT (IDCT) unit 214, a quantization (Q) unit 206, an inverse Q (IQ) unit 212, a first rate control unit 208, and a coding unit 210.

The coding priority control unit 200 determines a priority of each macro block (MB) using a coding priority map, which will be described later, so that a portion having a large error between a current image and a reference image, i.e., a previous image, is encoded prior to other portions. The coding priority control unit 200 receives an image and transmits an MB having a higher coding priority than other MBs to the coding unit 210.

More specifically, the coding priority control unit 200 obtains a mean error in each MB between a current image and a reference image, arranges MBs in order of mean error size, selects a plurality of MBs to be encoded at a predetermined bitrate from among the arranged MBs, and makes a coding priority map describing positions of a plurality of CPs of each selected MB. The coding priority map will be described later.

Unlike a conventional block-based encoding apparatus which sequentially encodes MBs in an image in positional order, the video encoding apparatus according to the embodiment of the present invention encodes a portion having a large error between images or a significant portion prior to other portions in an image, thereby improving entire picture quality of a restored image. In other words, a bitrate can be controlled to provide desired picture quality even at a limited bitrate. In particular, constant Quality of Service (QoS) can be provided for video service in a low-bitrate environment such as wireless communication.

The ME/MC unit 218 receives the coding priority map describing positions of a plurality of CPs of each MB to be encoded prior to other MBs, compensates for motion vectors of the respective CPs of each MB based on the coding priority map, and transmits the compensated motion vectors of each MB and the coding priority map to the coding unit 210. The video encoding apparatus according to the exemplary embodiment of the present invention compensates for the motion vectors using an affine motion model based on a plurality of CPs. In other words, unlike conventional technology using only translation of a block, the exemplary embodiments of the present invention can affinely describe complex motions such as translation, rotation, scaling, etc. in an image by using a motion vector of a predetermined CP to be encoded prior to other CPs. Therefore, the exemplary embodiments of the present invention allow effective video representation with a small amount of motion information.

According to the coding priority determined by the coding priority control unit 200, the second rate control unit 220 controls the ME/MC unit 218 to compensate for a mesh-based motion vector until a predetermined result is obtained. In detail, MC is continued until an amount of coded bits, QoS, computing time, or the like reaches a predetermined threshold. Various conditions can be set according to a user's application range. The predetermined threshold may be input by a user or set through simulation. In addition, MC may not be repeated when necessary or may be stopped when the predetermined threshold is obtained within a predetermined number of repetitions.

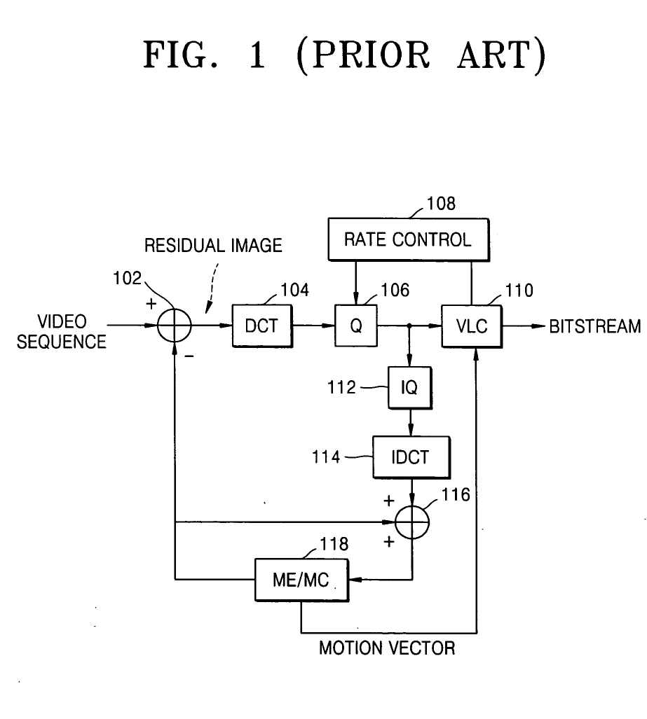

The DCT unit 204, the IDCT unit 214, the Q unit 206, the IQ unit 212, and the coding unit 210 are the same as the DCT unit 104, the IDCT unit 114, the Q unit 106, the IQ unit 112, and the coding unit 110, respectively, shown in FIG. 1. As in the conventional technology, the first rate control unit 208 controls a bitrate by adjusting a Q parameter (QP) when a residual image formed by a difference between a current image and a reference image is encoded.

The following description concerns a mesh-based video encoding method performed by a video encoding apparatus having a structure described with reference to FIG. 2.

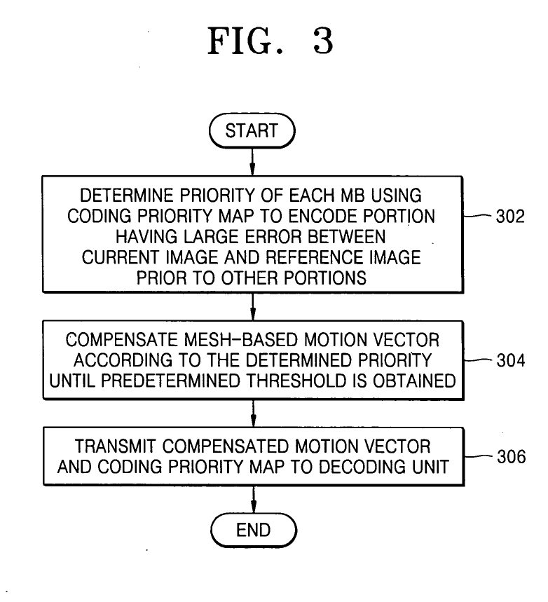

FIG. 3 is a flowchart of a mesh-based video encoding method using an affine motion model, according to an exemplary embodiment of the present invention. Referring to FIG. 3, to encode a portion having a large error between a current image and a reference image prior to other portions, priority of each MB is determined using a coding priority map in operation 302. A mesh-based motion vector is compensated for according to the determined priority until a predetermined threshold is obtained in operation 304. The compensated motion vector and the coding priority map are transmitted to the coding unit 210 in operation 306.

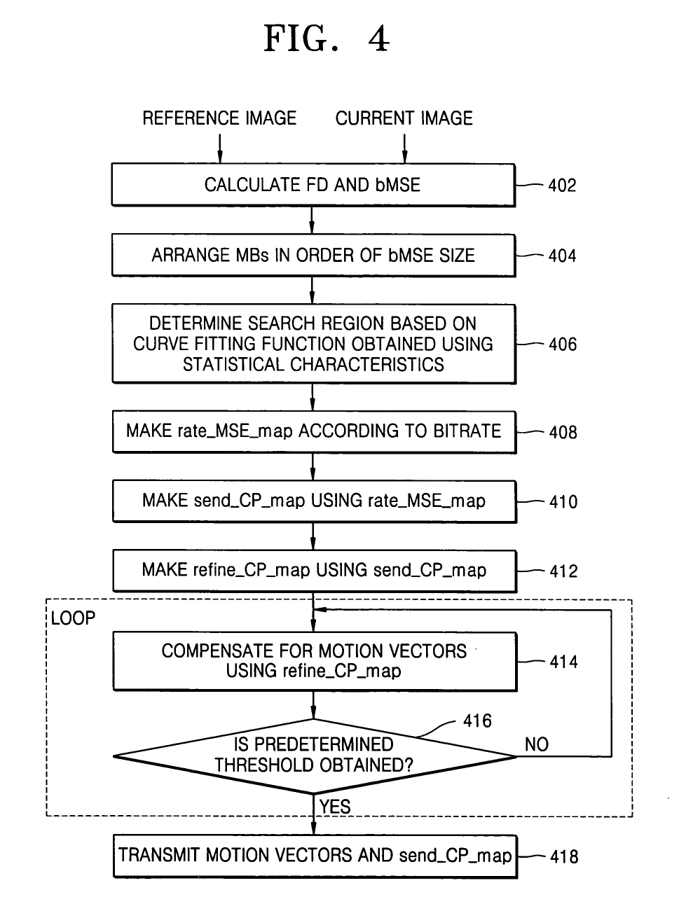

FIG. 4 is a detailed flowchart of the mesh-based video encoding method according to the exemplary embodiment illustrated in FIG. 3. To determine the priority of each MB in operation 302, a mean error in each MB between the current image and the reference image is obtained. MBs are arranged in order of mean error size. A plurality of MBs to be encoded at a predetermined bitrate prior to other MBs are selected from among the arranged MBs. The coding priority map describing positions of a plurality of CPs of each selected MB is made. These operations will be described in detail below.

FIG. 4 shows an algorithm including operations described below. In FIG. 4, operations before a loop are performed to determine priority of each MB. A current image and a preference image are received and a mean error therebetween is calculated in operation 402. In detail, a frame difference (FD) that is a difference between the entire current image and the entire preference image and a block mean square error (bMSE) that is an error between a block in the current image and a corresponding block at the same position as the current block in the preference image are calculated. Based on a result of the calculation, MBs are arranged in order of bMSE size in operation 404.

To determine a size of a search region, an optimal curve fitting function is obtained using the FD in a least mean square (LMS) method and a size of an optimal search region is estimated from the FD based on the curve fitting function in operation 406. If the size of the search region is very large in mesh-based encoding, a mesh structure may be broken, thereby deteriorating picture quality of a restored image and increasing an amount of computation. Accordingly, the search region needs to be determined to have an appropriate size.

To determine coding priority, various maps are made according to a bitrate. MBs having high priority are selected according to a bitrate, and a map representing the MBs to be encoded is made in operation 408. The map representing the MBs is denoted by rate_MSE_map. A map representing CPs of the MBs represented to be encoded in the rate_MSE_map is made in operation 410. The map representing the CPs is denoted by send_CP_map. A map representing CPs to be subjected to MC including the CPs to be encoded and CPs in a predetermined range around the CPs to be encoded is made using the send_CP_map in operation 412. The map representing CPs to be subjected to MC is denoted by refine_CP_map. Hereinafter, for clarity of the description, the send_CP_map and the refine_CP_map representing CPs are referred to as a coding priority map. Each of the maps will be described later. Operations 402 through 412 are performed to determine the MBs to be encoded prior to other MBs in operation 302 shown in FIG. 3.

To compensate for the motion vector according to the determined priority in operation 304, the exemplary embodiment of the present invention uses mesh-based MC using an affine motion model, unlike the conventional block-based method. In detail, motion vectors of the respective CPs are compensated for using the refine_CP_map in operation 414. The MC is repeated until a result of the MC reaches a predetermined threshold in operation 416. The loop of operations 414 and 416 may not be repeated when necessary or may be stopped when the predetermined threshold is obtained within a predetermined number of repetitions. The predetermined threshold may be set by a user's input or set through simulation. Various conditions can be set according to a user's application range. The various conditions may include an amount of coded bits, QoS, and computing time. Also, the various conditions may be set according to desired QoS.

The compensated motion vectors of the respective CPs and the coding priority map are transmitted to the coding unit 210 in operation 418. The coding unit 210 entropy encodes the compensated motion vectors, the coding priority map, and quantized DCT coefficients and transmits a result of the entropy encoding to a decoding apparatus (not shown). Accordingly, a motion in a block can be effectively represented with a small amount of information by using a more affine motion model than a simple motion model used in conventional block-based encoding. In addition, in the exemplary embodiment of the present invention, a bitrate can be controlled by encoding a residual image as in conventional technology and also by using motion information in a low-bitrate encoding environment. In addition, since computing power and encoding bits are selectively assigned to a block, having higher significance than other blocks, prior to the other blocks, encoding efficiency can be increased and entire picture quality of a restored image can be improved.

Embodiments of the present invention will be described in more detail by explaining examples of various maps used to determine coding priority.

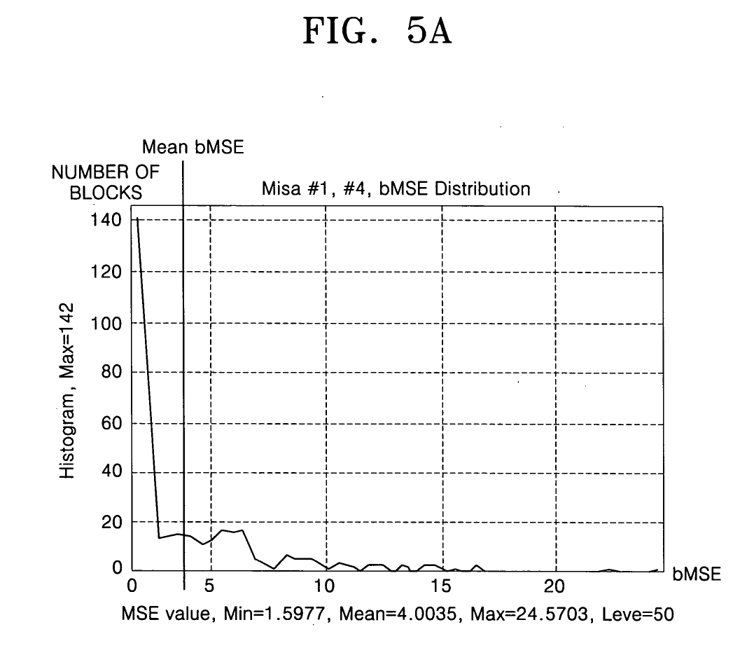

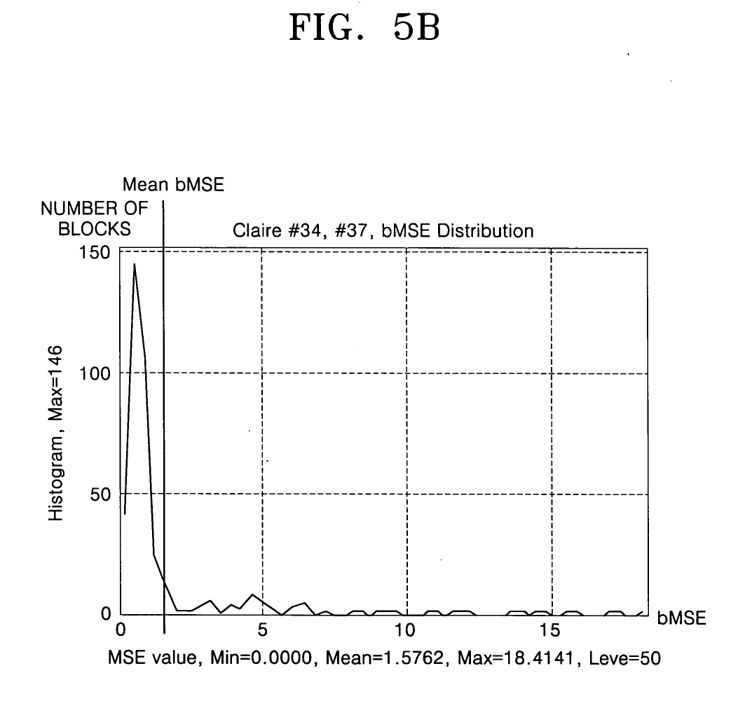

To determine coding priority of each MB, a map denoted by MSE_map may be made using bMSEs between images. FIGS. 5A and 5B illustrate distributions of bMSEs between a current image and a reference image where an MB is a coding unit. In graphs shown in FIGS. 5A and 5B, an x-axis indicates a bMSE and a y-axis indicates the number of blocks. A solid line parallel with the y-axis indicates a mean bMSE with respect to an entire image. As shown in FIGS. 5A and 5B, most of MBs are present below the mean bMSE (i.e., on the left side of the solid line). The bMSEs on the left side of the solid line are rarely perceived by human sight. The bMSEs above the mean bMSE (i.e., on the right side of the solid line) are sensitively perceived by human vision. Accordingly, to guarantee restored picture quality and increase coding efficiency, when ME/MC is performed, priority needs to be given to MBs having bMSEs on the right side of the solid line. The number of blocks to be encoded is calculated according to a desired bitrate and MBs having higher priority than other MBs are sequentially transmitted, so that predetermined restored picture quality can be guaranteed and coding efficiency can be increased. Here, the number of blocks to be encoded can be set to n % of a total number of blocks, such as 25%, 50%, 75%, or 100%, according to a bitrate. As such, a conventional problem in that MBs in an image are sequentially encoded just in positional order regardless of significance of the MBs can be overcome.

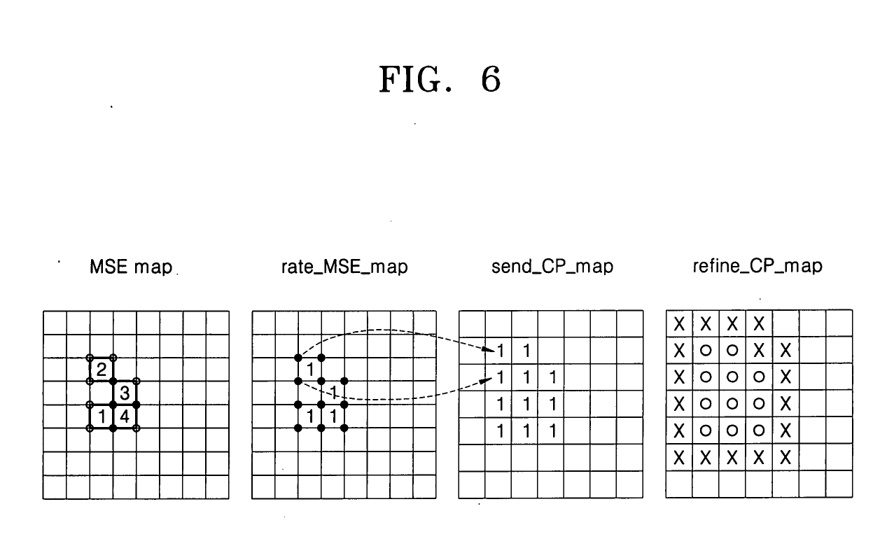

FIG. 6 illustrates examples of a coding priority map used in embodiments of the present invention. Various types of maps can be made using bMSEs. In an MSE map shown in FIG. 6, MBs are numbered according to order of bMSE size. For clarity of the description, only four MBs having high priority are represented. An encoding unit may be a block or an MB and a size of the block or the MB may be adjusted. However, in the exemplary embodiments of the present invention, it is assumed that the encoding unit is a 16×16 pixel MB. In FIG. 6, a black circle indicates a CP shared by a plurality of MBs during ME and a white circle indicates a CP used for ME of only a single MB. On the MSE map, a single rectangular section indicates a block or an MB region. Information regarding only MBs represented on a coding priority map among all MBs in an image is encoded prior to other MBs.

In FIG. 6, a map denoted by rate_MSE_map represents MBs determined to be encoded prior to other MBs according to a bitrate based on the priority represented on the MSE map. On the rate_MSE_map, a single rectangular section is an MB region.

On maps denoted by send_CP_map and refine_CP_map illustrated in FIG. 6, a single rectangular section does not indicate an MB but a position of four points (CPs) of the MB. A dotted arrow shows a correspondence relationship between a CP of an MB on the rate_MSE_map and a rectangular section on the send_CP_map. On the rate_MSE_map, information at a boundary of an image does not largely influence entire encoding performance, and therefore, among motion information of CPs at the image boundary, only x- or y-direction information is used. In other words, only x-direction information is used for CPs at the image boundary in a horizontal direction and only y-direction information is used for CPs at the image boundary in a vertical direction.

In embodiments of the present invention, instead of a simple motion model representing only translation in a block, an affine motion model representing CPs of a block is used for MC. Accordingly, motion can be effectively represented with a small amount of information.

On the refine_CP_map shown in FIG. 6, “0” denotes a position of a CP having four or more adjacent CPs with a value of “1” on the send_CP_map and “X” denotes a position of a CP having one or more adjacent CPs with the value “1” on the send_CP_map. The “0” and “X” sections on the refine_CP_map indicate positions used during MC. A motion vector of a single CP is determined by adjacent MBs sharing the CP, and therefore, a motion vector of a CP positioned at an “0” section is influenced by motion vectors of CPs (positioned at “X” sections) of adjacent MBs sharing the CP at the “0” section. MC is performed considering this situation. Finally, only information represented on the send_CP_map is transmitted to a decoder.

The above-described maps used to determined encoding priority are just examples used in the exemplary embodiments of the present invention, and various other types of maps can be used.

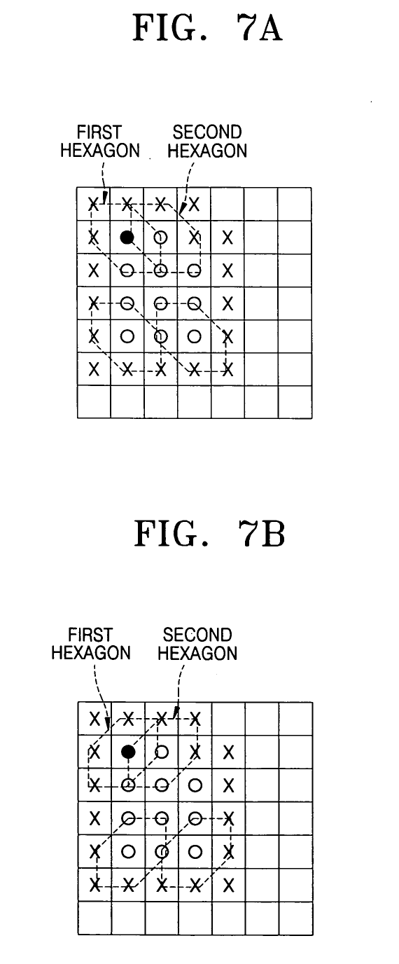

FIGS. 7A and 7B illustrate MC using an affine motion model according to an embodiment of the present invention. Referring to FIGS. 7A and 7B, instead of a conventional block-based MC method, a mesh-based MC method using CPs is used as an MC method using an affine motion model. In other words, as shown in FIG. 7A, six CPs (forming a dotted hexagon) around a CP (i.e., a black circle) whose motion vector is to be obtained and information regarding sections of the six CPs are used. Such MC method is referred to as a hexagon matching method. FIGS. 7A and 7B illustrate two methods of forming a hexagon. A motion vector of a current CP is used to obtain motion vectors of other CPs adjacent to the current CP. As such, motion vectors of four points (CPs) of a current MB can be obtained. Furthermore, after MC is completed with respect to an entire image, whether to repeat the MC may be determined according to a result of the MC. In other words, the MC can be repeated until the result of the MC reaches a predetermined threshold. The MC may not be repeated when necessary or may be stopped when the predetermined threshold is obtained within a predetermined number of repetitions. The predetermined threshold may set an amount of coded bits, QoS, computing time, or the like. Various conditions can be set according to a user's application range.

If the result of the MC reaches the predetermined threshold, the MC is stopped and the compensated motion vectors and the send_CP_map are transmitted to a decoding apparatus.

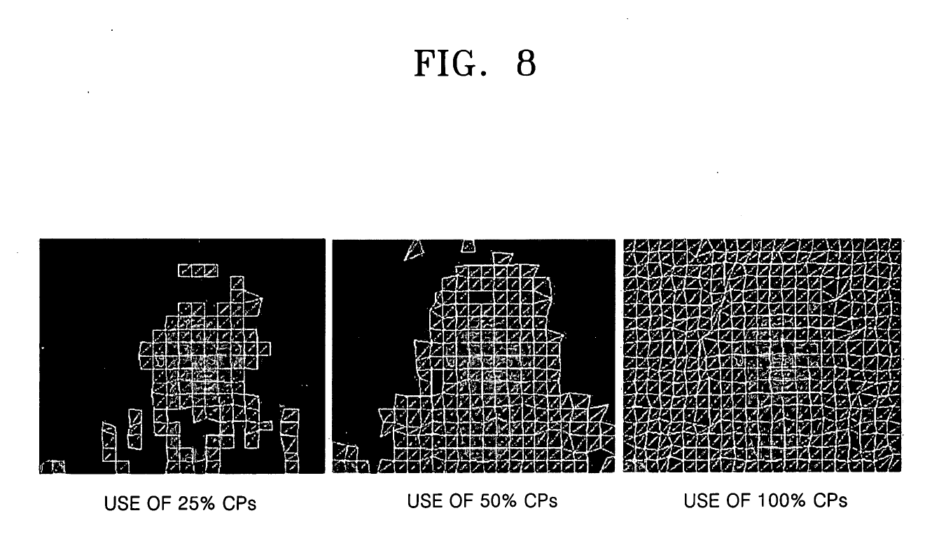

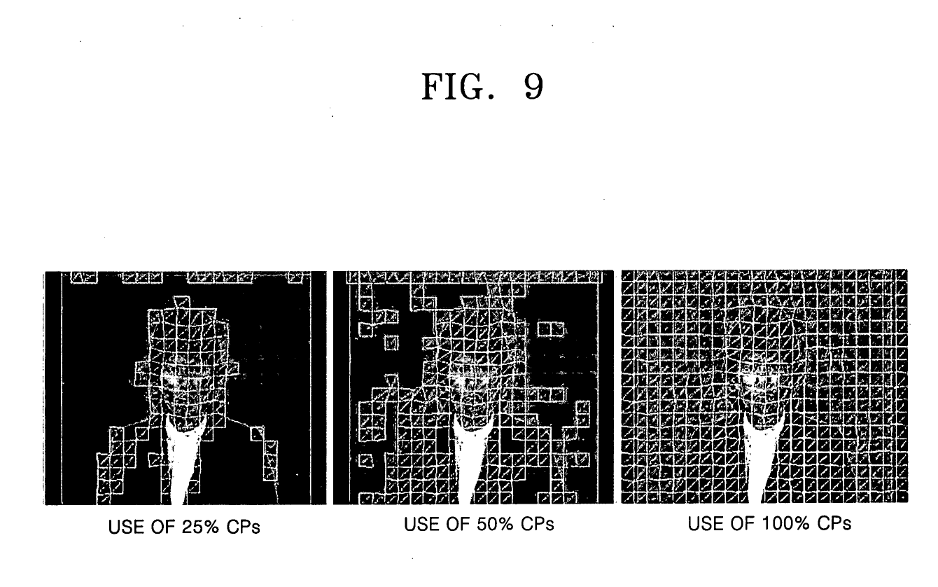

FIGS. 8 and 9 illustrate mesh structures according to bitrates in embodiments of the present invention. Referring to FIGS. 8 and 9, positions of MBs formed by n % CPs depending upon a bitrate and motion vectors of the CPs are represented. The motion vectors of the respective CPs transform rectangular MBs into a triangular and rectangular mesh structure.

Accordingly, even if channels or coding bits are limited, only n %, e.g., 25%, 50%, 75%, or 100%, of a total number of CPs (or blocks) are encoded and transmitted, so that resources can be efficiently used. In other words, scalable coding is possible.

Meanwhile, a decoding method and apparatus can be provided using the same principles as those of an encoding method and apparatus according to exemplary embodiments of the present invention. In other words, to decode an image based on MC, a coding priority map, which represents at least one block encoded prior to other blocks in a current image based on an error between the current image and a reference image and a predetermined bitrate, may be received from the encoding apparatus; the at least one block that was encoded prior to the other blocks may be extracted, and the at least one block extracted from the coding priority map may be selectively decoded.

The decoding apparatus may include a coding priority extraction unit receiving a coding priority map, which represents at least one block encoded prior to other blocks in a current image based on an error between the current image and a reference image and a predetermined bitrate, and extracting the at least one block that was encoded prior to the other blocks. The decoding apparatus may also include a decoding unit selectively decoding the at least one block extracted from the coding priority map. The decoding method and apparatus according to embodiments of the present invention perform decoding using the coding priority map based on the same principles as those of the encoding method and apparatus described above. Thus, detailed descriptions thereof will be omitted.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical disks, and carrier waves (such as data transmission through the Internet). The computer readable recording medium can also be distributed over network coupled computer systems so that the computer readable code is stored and executed in a distributed fashion.

As described above, the present invention uses a more affine motion model than a conventional block-based coding method, thereby effectively representing a motion in a block with a small amount of information.

In addition, a bitrate can be controlled by encoding a residual image and also by using motion information in a low-bitrate encoding environment.

Furthermore, since computing power and encoding bits are selectively assigned to a block having higher significance than other blocks prior to the other blocks, encoding efficiency can be increased. This feature can be directly used to encode a region of interest (ROI). Consequently, a portion having a large error between images or a significant portion is encoded prior to other portions in an image, thereby improving entire picture quality of a restored image.

Moreover, even if channels or coding bits are limited, only n %, e.g., 25%, 50%, 75%, or 100%, of a total number of CPs (or blocks) are encoded and transmitted, so that resources can be efficiently used. In other words, scalable coding is possible.

As a result, various types of trade-off become possible in terms of computation amount, bitrate, and restored picture quality. In particular, the present invention can be used to provide various types of QoS in various application fields including video service in a low-bitrate environment such as wireless communication.

While this invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

1. A video encoding method based on motion compensation, comprising:
making a coding priority map representing at least one block in a current image to be encoded prior to other blocks in the current image based on an error between the current image and a reference image and a predetermined bitrate; and
encoding the at least one block represented on the coding priority map among the blocks in the current image.

2. The video encoding method of claim 1, wherein the making the coding priority map comprises:
obtaining block mean errors between the current image and the reference image and arranging the blocks in order of block mean error size;
determining a predetermined number of blocks to be encoded prior to other blocks among the arranged blocks according to the predetermined bitrate; and
making the coding priority map representing the predetermined number of blocks and positions of respective control points of the predetermined number of blocks.

3. The video encoding method of claim 2, wherein the encoding the at least one block comprises:
compensating for motion vectors of the respective control points of the predetermined number of blocks based on the coding priority map; and
encoding the compensated motion vectors and the coding priority map and transmitting encoded results to a decoding apparatus.

4. The video encoding method of claim 2, wherein the determining of the predetermined number of blocks comprises adjusting either of a number of blocks to be encoded prior to other blocks among all of the blocks in the current image and a number of control points of the blocks to be encoded, thereby satisfying the predetermined bitrate.

5. The video encoding method of claim 3, wherein the compensating for the motion vectors comprises:
compensating for the motion vectors of the respective control points of the predetermined number of blocks based on the coding priority map using mesh-based motion compensation; and
stopping the compensating when the compensated motion vectors reach a predetermined threshold.

6. The video encoding method of claim 5, wherein the predetermined threshold is set by a user's input or is set through simulation in one condition selected from the group consisting of a number of bits to be coded, Quality of Service (QoS), and computing time.

7. The video encoding method of claim 5, wherein the mesh-based motion compensation comprises a process of compensating for the motion vectors of the respective control points of the predetermined number of blocks using an affine motion model.

8. A video encoding apparatus based on motion compensation, comprising:
a coding priority control unit making a coding priority map representing at least one block to be encoded prior to other blocks among all blocks in a current image based on an error between the current image and a reference image and a predetermined bitrate; and
a coding unit encoding the at least one block represented on the coding priority map among the blocks in the current image.

9. The video encoding apparatus of claim 8, further comprising:
a motion estimation and motion compensation unit compensating for motion vectors of respective control points of a predetermined number of blocks based on the coding priority map and transmitting the compensated motion vectors and the coding priority map to the coding unit; and
a rate control unit stopping the compensating for the motion vectors of the respective control points when the compensated motion vectors reach a predetermined threshold.

10. A video decoding method based on motion compensation, comprising:
receiving a coding priority map, which represents at least one block encoded prior to other blocks in a current image based on an error between the current image and a reference image and a predetermined bitrate, from an encoding apparatus, and extracting the at least one block encoded prior to the other blocks from the coding priority map; and
decoding the at least one block extracted from the coding priority map.

11. A video decoding apparatus based on motion compensation, comprising:
a coding priority extraction unit receiving a coding priority map, which represents at least one block encoded prior to other blocks in a current image based on an error between the current image and a reference image and a predetermined bitrate, and extracting the at least one block encoded prior to the other blocks from the coding priority map; and
a decoding unit decoding the at least one block extracted from the coding priority map.
